(19) United States
(12) Patent Application Publication
(10) Pub. No.: US 2026/0025009 A1
(43) Pub. Date: Jan. 22, 2026

(54) MULTI-PACK CURRENT LIMIT ROLL UP

(71) Applicant: Caterpillar Inc., Peoria, IL (US)

(72) Inventors: Sathvick Shiva Kumar, Mandya (IN); Stephen A. Edwards, Peterborough (GB)

(73) Assignee: Caterpillar Inc., Peoria, IL (US)

(21) Appl. No.: 18/777,769

(22) Filed: Jul. 19, 2024

(51) Int. Cl. H02J 7/00

(52) U.S. Cl. CPC H02J 7/0014; H02J 7/00304; H02J 7/005; H02J 7/00714; H02J 2310/48

(57) ABSTRACT

A modular battery system includes a battery bus, multiple battery packs connectable in parallel to the battery bus to provide a system current, and a battery system controller. A battery pack includes multiple battery cells and provides a battery pack current to the battery bus. The battery system controller is configured to determine whether individual battery packs are online or offline, receive individual battery pack current limits of online battery packs and set a system level current limit of the battery system, determine system current and individual battery pack currents, compare the individual battery pack currents to their respective individual battery pack level current limit, update the system current limit according to the comparing, and scale a current demand for the individual battery pack currents using proportions of the measured system current and the updated system current limit.

### TECHNICAL FIELD

This document relates to rechargeable battery technology and in particular to techniques of activating multiple battery packs in parallel to power large moving work machines.

### BACKGROUND

Powering a large moving work machine (e.g., a wheel loader) with an electric motor requires a large mobile electric energy source that can provide current of tens to hundreds of Amperes (Amps). Multiple large capacity battery packs connected in parallel as battery a battery pack system can provide the sustained energy power needed by a large electric-powered moving work machine. The battery packs contain one or more battery strings of multiple battery modules. The battery modules may in turn, each include multiple battery cells arranged in series-parallel combinations based on the voltage, power, and energy requirements of the application. The battery packs can include battery pack controllers to manage different aspects of the battery packs such as bringing the battery packs online for discharging to drive a load or bringing the battery packs online for charging the battery cells of the battery pack.

Multiple battery packs can be brought online and brought offline according to the load demand and operating conditions of the work machine. A process for activating the battery packs should take into account the state of charge and the state of health of the battery packs to maximize the life of the batteries, and operating the battery packs should avoid breaching of the current, temperature, and voltage limits of the battery packs. Higher uncontrolled current drawing from the battery cells or higher controlled current charging the battery cells can lead to excessive heating of the battery cells that can reduce the battery health of the battery cells. The higher currents also can make it difficult to keep the voltage of the battery cells within the safe operating voltage level range. Published Patent Application WO 2023/072444 relates to a method for operating a battery system with multiple battery packs connected in parallel and each of which has a battery control unit for controlling and monitoring the corresponding battery pack and a switch unit for switching the corresponding battery pack on and off.

### SUMMARY OF THE INVENTION

Electric powered large moving work machines use large capacity battery systems. A large capacity battery system should be operated to avoid exceeding the operating limits of the batteries.

An example battery system includes a battery bus, multiple battery packs connectable in parallel to the battery bus to provide a system current, and a battery system controller. A battery pack includes multiple battery cells and provides a battery pack current to the battery bus. The battery system controller is configured to determine whether battery packs are online or offline; control current of online battery packs according to individual battery pack current limits of online battery packs and a system level current limit of the battery system; measure system level current and individual battery pack currents; compute current ratios including the individual battery pack currents and their respective individual battery pack level current limits; compute proportions of individual battery pack currents to the system level current; compute a correction factor using the determined current ratios and proportions; and compute an updated system current limit using the correction factor.

An example method of operating a machine battery system having multiple battery packs includes determining, using a battery system controller, whether individual battery packs are online or offline, and online and charging or online and discharging; controlling current of online battery packs according to individual battery pack current limits of online battery packs and a system level current limit of the battery system; measuring system level current and individual battery pack currents; computing current ratios including the individual battery pack currents and their respective individual battery pack level current limits; computing proportions of individual battery pack currents to the system level current; computing a correction factor using the determined current ratios and proportions; and computing an updated system current limit using the correction factor.

### BRIEF DESCRIPTION OF THE DRAWINGS

FIG. 1 is an elevation view depicting an example work machine in accordance with this disclosure.

FIG. 2 is a block diagram of a modular battery system for a work machine in accordance with this disclosure.

FIG. 3 is a diagram of an example of a battery module in accordance with this disclosure.

FIG. 4 is a diagram of another example of a modular battery system in accordance with this disclosure.

FIGS. 5 and 6 are diagrams illustrating an example of operating a modular battery system in accordance with this disclosure.

FIGS. 7 and 8 are diagrams illustrating another example of operating a modular battery system in accordance with this disclosure.

FIG. 9 is a diagram illustrating another example of operating a modular battery system in accordance with this disclosure.

FIG. 10 is a diagram illustrating another example of operating a modular battery system in accordance with this disclosure.

FIG. 11 is a flow diagram of an example of a method operating a machine battery system in accordance with this disclosure.

### DETAILED DESCRIPTION

Examples according to this disclosure are directed to methods and systems for automatically operating a large capacity battery system safely. A battery system can include multiple battery packs connected in parallel and the battery packs can include multiple large capacity battery cells connected in series and in parallel. The battery packs of the large capacity battery system should be automatically operated in manner that is within the operating limits of the battery packs.

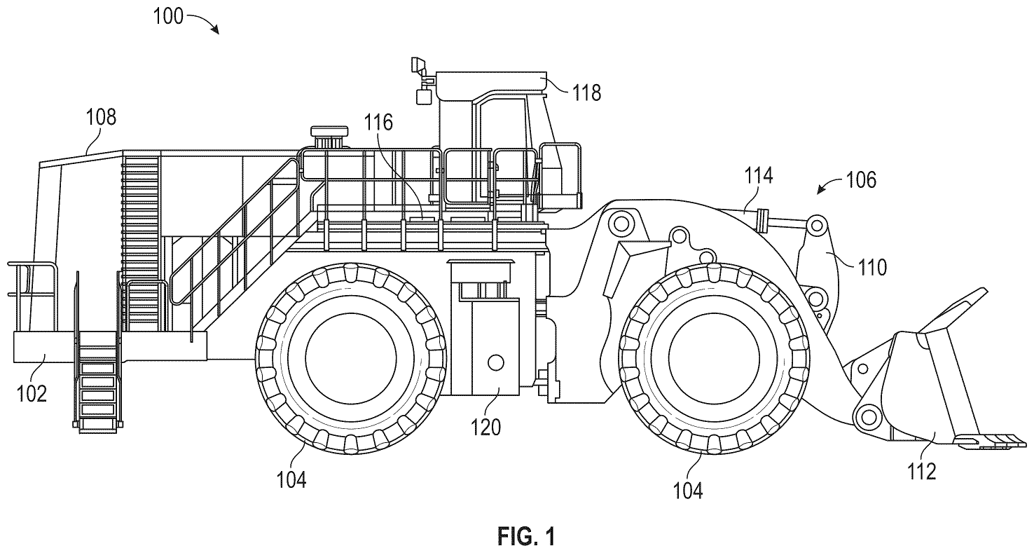

FIG. 1 depicts an example machine 100 in accordance with this disclosure. In FIG. 1, machine 100 includes frame 102, wheels 104, implement 106, and a speed control system implemented in one or more on-board electronic devices like, for example, an electronic control unit or ECU. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an electric motor to propel the machine over various terrain via wheels 104. In some examples, multiple electric motors are included in multiple enclosures at multiple locations of the machine 100.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 116. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage assembly 110 to dig into and remove dirt, rock, sand, etc. from a portion of the work site and deposit this load in another location. Machine 100 can include a battery compartment connected to frame 102 and including a battery system 120. Battery system 120 is electrically coupled to the one or more electric motors of the machine 100.

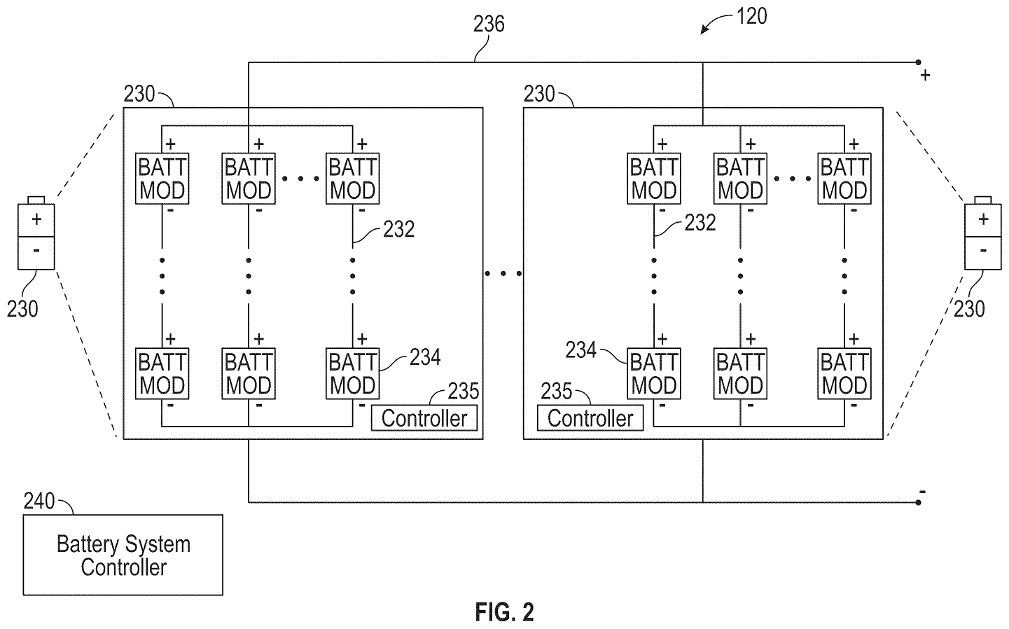

FIG. 2 is a diagram of an example of a modular battery system 120. The battery system 120 can be used to provide power to a machine, such as the example machine 100 of FIG. 1. The battery system 120 includes multiple battery packs 230 (e.g., two to eight battery packs). Each battery pack 230 can include multiple battery module 232 (e.g., two to five battery strings). Each battery module 232 includes multiple battery modules 234. Each battery module 234 includes multiple battery cells.

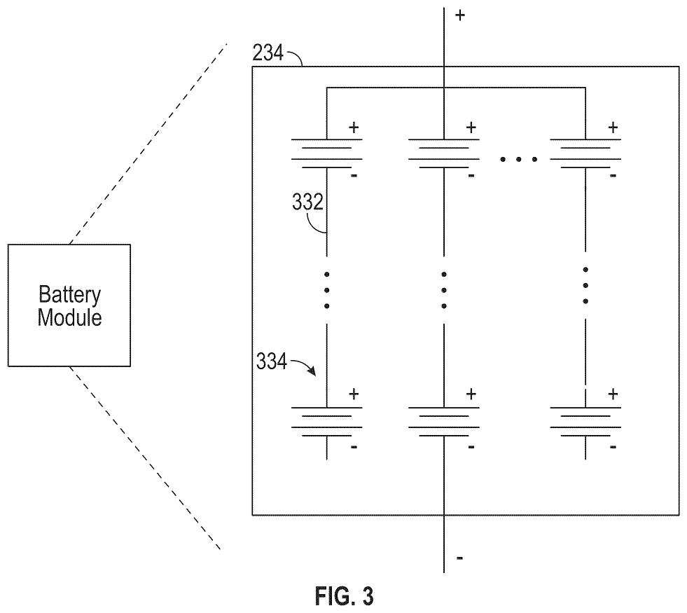

FIG. 3 is a diagram of an example of a battery module 234. The battery module 234 includes multiple large capacity batteries 334 (e.g., a 750 Volt, 80 Amp-hour battery, or 60 kilowatt-hours). The batteries 334 are connected in series-parallel combinations depending on the energy and voltage requirements of the application for the battery module 234.

The battery packs 230 are connectable in parallel as a battery pack system to the battery bus 236 that provides direct current (DC) power to other components of the machine. The battery packs 230 may each include a pack controller 235 to bring the battery strings and the battery pack online, and configure the battery strings and battery pack for discharging or charging.

Because the battery system 120 is modular, less battery packs 230 can be connected in parallel during smaller loads, and more battery packs 230 can be connected in parallel for larger loads. The battery system 120 includes a battery system controller 240. The battery system controller 240 and pack controllers 235 may include processing circuitry that includes logic to perform the functions described. The processing circuitry may include a microprocessor, application specific integrated circuit (ASIC), field programmable gate array (FPGA), or other type of processor, interpreting or executing instructions in software or firmware. In some examples, battery system includes a logic sequencer circuit. A logic sequencer refers to a state machine or other circuit that sequentially steps through a fixed series of steps to perform the functions described. A logic sequencer circuit can be implemented using hardware, firmware, or software. In some examples, one controller circuit (e.g., one processor) performs the functions of both the battery system controller and the pack controllers using separate processes running on the same controller circuit.

The individual battery packs 230 may be brought online and taken offline based on load conditions and operating conditions of the battery packs 230. The battery packs 230 have similar capacity and voltage rating, and the current drawn while discharging the battery packs 230 or the current consumed while charging the battery packs 230 is typically assumed to be evenly split among the battery packs 230. In reality, there exist current imbalances from one battery pack to another due to minor differences between the battery packs 230 in terms of voltage, aging of the battery cells, and electrical resistance of the battery pack. Additionally, when sequencing activation of the battery packs 230 to bring them online, there exist inter battery pack current flows based on the voltage differences between the battery packs 230. Because the differences between the battery packs 230 are minor, the current levels of the inter battery pack currents are usually not very high. However, when providing charge current and discharge current at the levels of the work machine, the overall battery system current limits should account for not only the individual battery pack current limits but also the inter-pack current flows. Not accounting for the inter-pack current flows may cause the individual battery pack current to breach the current limit for the battery pack. Under high load conditions, breaching the battery pack current limit may have more severe implications for safe operation of the battery system 120. The automatic operation of the battery system 120 should optimize system level current limits based on the prevailing conditions of the individual battery packs 230 and the overall battery system 120.

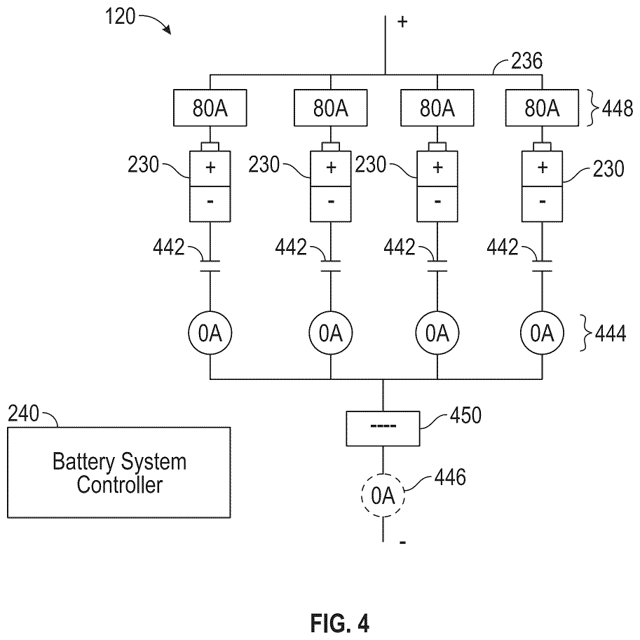

FIG. 4 is a diagram of another example of a modular battery system 120. The battery system 120 shows four battery packs 230. The battery system 120 includes contactor switches 442 to connect the battery packs 230. Because the battery packs 230 contain large capacity battery cells, the battery contactor switches 442 may be rated to 100 Amperes (100A) or greater. The battery system 120 includes a pack current sensor 444 for each battery pack 230 to monitor the current each individual battery pack. The battery system 120 also includes a system current sensor 446 to monitor the system level current drawn by the battery system 120. The diagram also shows pack current limit blocks 448 to show the current limit for the individual battery packs 230. The pack current limit blocks 448 may be implemented as registers of the battery system controller 240, or registers of the pack controllers writable by the battery system controller 240. The diagram also shows system current limit block 450 to show the system level current limit. The system current limit block 450 may be implemented as a register in the battery system controller 240. The pack current limit blocks 448 of FIG. 3 show the current limit for the individual battery packs 230 set at 80A, and the system current limit block 450 shows that the system current limit as not yet set. The contactor switches 442 are shown open in FIG. 4.

To manage charging and discharging of the battery packs 230 of the battery system 120, the pack controllers 235 are configured (e.g., through programming) to compute battery pack level current limits of individual battery packs 230. The pack controllers 235 may determine the current limit for its individual battery pack 230 using information such as the voltage of the battery pack, the state of charge of the battery pack, state of health of the battery pack, temperature of the battery pack, etc. The state of health of the battery pack may include information such as the internal resistance of the battery pack, internal resistance of battery cells of the battery pack, age of the battery pack, etc. The pack controllers 235 send the computed battery pack level current limit to the battery system controller 240. Individual battery packs 230 of the battery system 120 may have different battery pack level current limits as indicated in the pack current limit blocks 448. The pack controllers 235 compute charge and discharge current limits. The pack controllers 235 may recurrently compute and send battery pack level current limits to the system controller 240.

The pack controllers receive measurements of their respective battery pack from the pack level current sensors 444. The battery system controller 240 receives the battery pack level currents from the pack controllers 235. The battery system level controller 240 also measures the system level current of the battery system 120 using system current sensor 446. The battery system controller 240 may also determine inter battery pack current flows using the output of the pack current sensors 444 and the system level current sensor 446. Using the current limit information and operating current information, the battery system controller 240 computes an updated system level current limit. The battery system controller 240 also computes a ratio that includes the measured system current and the updated system current limit. The battery system controller 240 uses the ratio to scale all the individual battery pack currents. There may be a worst performing battery pack that may be closest to exceeding its pack current limit or may have breached its pack current limit. The scaling of the individual battery pack currents reduces the current of the worst performing battery pack away from its pack current limit.

According to some examples, the battery system controller 240 determines the battery packs that are online and offline. The battery system controller 240 uses the output of the pack current sensors 444 to differentiate between the battery packs that are online and charging and the battery packs that are online and discharging. The battery system controller 240 recurrently computes a charging current limit and a discharging current limit for each of the individual battery packs 230. The battery system controller 240 sets a system level charge current limit and a system level discharge current limit. Using the charging current limit information and operating charging current information, the battery system controller 240 computes an updated system level charge current limit and uses the discharging current limit information and operating discharging current information to compute an updated system level discharge current limit. The charging current of the battery packs that are online and charging is scaled using a ratio that includes that includes the measured system charging current and the updated system charging current limit, and the discharging current of the battery packs that are online and discharging is scaled using a ratio that includes that includes the measured system discharging current and the updated system discharging current limit.

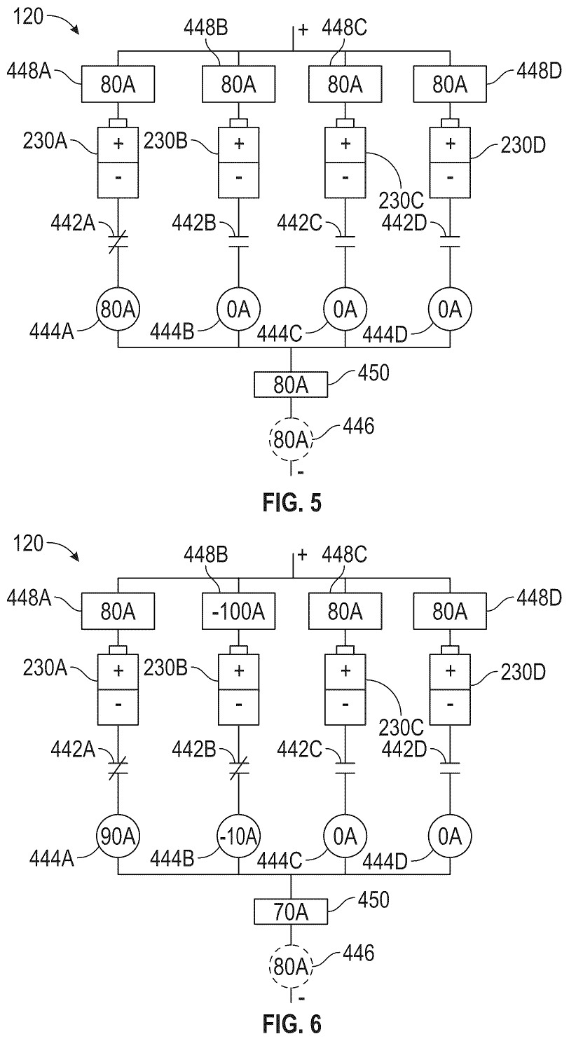

FIGS. 5 and 6 are diagrams illustrating an example of operating the modular battery system 120 of FIG. 4. In FIG. 5, contactor switch 442A is closed and battery pack 230A is online and charging. Current sensor 444A shows that battery pack 230A is receiving 80 Amps (80A) of charging current. The other battery packs are offline. The pack controllers 235 have calculated the same pack level charging current limit for all the battery packs, which is 80 Amps. The pack controllers 235 may calculate different current limits for different battery packs. The system charging current limit is set to 80 Amps by the battery system controller 240 and the system current sensor 446 senses a system level charging current of 80 Amps.

In FIG. 6, the contactor switch 442B for battery pack 230B is closed and battery pack 230B comes online and is discharging. The pack controller 235 for battery pack 230B has calculated a battery pack discharging current limit of 100 Amps for battery pack 230B. Current sensor 444B shows that battery pack 230B is discharging 10 Amps. The battery system controller 240 uses the information from pack current sensors 444A, 444B, and system current sensor 446 to compute that the discharging of battery pack 230B is taken up as charge current by battery pack 230A. This inter battery pack current flow raises the current in battery pack 230A to 90 Amps as shown in current sensor 444A, which is greater than the battery pack level current limit received by the battery system controller 240. In response to the output of current sensor 444A, the battery system controller 240 computes an updated system level charging current limit of 70 Amps. The battery system 120 will scale the charge current of the individual battery packs. The scaling is based on the proportion of the individual battery pack's charge or discharge current to the overall system level current. The scaling is equal to the updated system level charging current limit times the proportion of the individual battery pack's current of the total system level current, plus the discharging battery pack's discharge current times the proportion of the individual battery pack's current of the total system level current.

For the example of FIG. 6, the scaling for battery pack 230A is scaling=(70)(0.875)+(10)(0.875)=80A. The scaled current of 80 A is 10A greater than the updated system current limit of 70A. This 10A is accounted for in the discharge current of battery pack 230A.

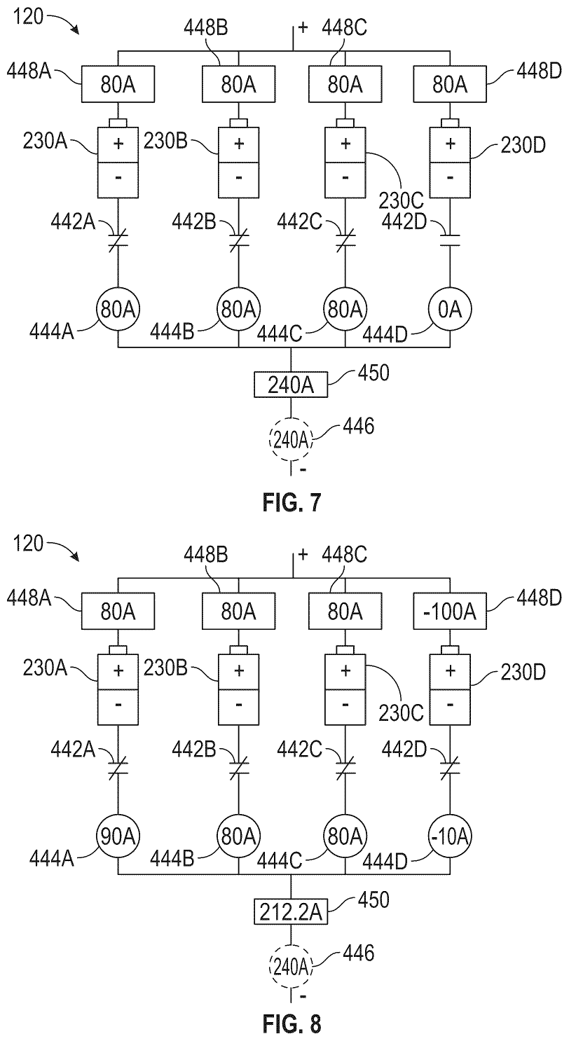

FIGS. 7 and 8 are diagrams illustrating another example of operating the modular battery system 120 of FIG. 3. In FIG. 7, contactor switches 442A, 442B, 442C are closed. Battery packs 230A, 230B, 230C are online and charging. Battery pack 230D is offline and contactor switch 342D is open. As shown in the pack current limit blocks 448A-D, the pack controllers 235 have calculated the same pack level charging current limit for all the battery packs, which is 80 Amps. Current sensors 444A, 444B, 444C show that the battery packs are receiving 80 Amps of charging current. The system current sensor 446 senses a system level charging current of 240 Amps, and the battery system controller 240 has set the system current limit to 240 Amps.

In FIG. 8, the contactor switch 442D for battery pack 230D is closed and battery pack 230D comes online and is discharging. The pack controller 235 for battery pack 230D has calculated a battery pack discharging current limit of 100 Amps for battery pack 230D. Current sensor 444D shows that battery pack 230D discharges 10 Amps. The battery system controller 240 uses the information from pack current sensors 444A, 444D, and system current sensor 446 to compute that the discharging of battery pack 230D is taken up as charge current by battery pack 230A. The inter battery pack current flow raises the current in battery pack 230A to 90 Amps, which is above the calculated battery pack charging current limit of 80 Amps for battery pack 230A. In response to the output of current sensor 444A, the battery system controller 240 computes an updated system level charging current limit of 212.2 Amps.

The battery system 120 will scale all the individual battery pack charging currents. For the example of FIG. 8, the scaling for battery pack 230A is

$$scaling = ( 212 \text{.2} ) ( \text{.036} ) + ( 10 ) ( \text{.036} ) = 76.4 + 3.6 = 80 A .$$

For battery pack 230B the scaling is

$$scaling = 67. 9 + 3.2 = 71.1 A .$$

For battery pack 230C the scaling is

$$scaling = 67. 9 + 3.2 = 71.1 A .$$

The sum of scaled currents is 80A+71.1 A+71.1 A=222A, which is 10A greater than the updated system current limit of 212.2 A. This 10A is accounted for in the discharge current of battery pack 230D.

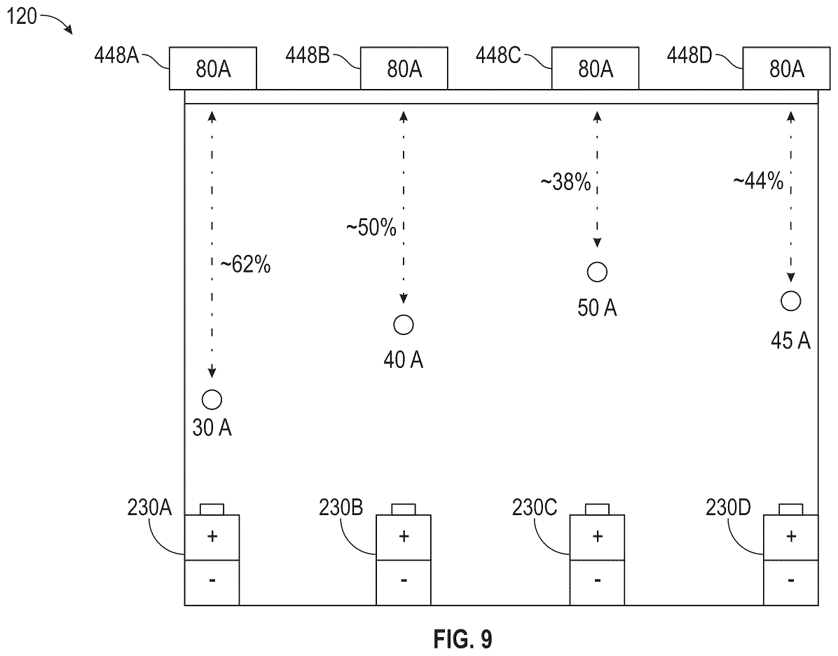

FIG. 9 is a diagram illustrating another example of operating a modular battery system 120. The battery system controller 240 may compute an updated system level charging current limit or system level discharging current limit even though none of the pack level current limits are breached. The diagram shows four battery packs 230A-D and four charging current limit blocks 348A-348D. The battery system controller 240 has received the same pack level charging current limit from the pack controllers 235, which is 80 Amps. The current sensors (not shown) indicate that the charging current measured by the current sensors is different for each of the battery packs. The charging current for battery pack 230A is 30 Amps, the charging current for battery pack 230B is 40 Amps, the charging current for battery pack 230C is 50 Amps, and the charging current for battery pack 230D is 45 Amps. The battery system controller 240 dynamically updates the system level charging current limit to tend to the worst performing battery pack so that the pack level current limits are not breached and the state of health of the worst performing battery pack is maintained. The battery system controller 240 may perform the same process regarding the discharging current limits of the battery packs.

To identify the worst performing battery pack, the battery system controller 240 determines, for each battery pack, a ratio that includes the measured individual battery pack current and the current limit received for the battery pack. The battery system controller 240 then calculates how much current an individual battery pack can take before it reaches the battery pack current limit. The battery system controller 240 may calculate a ratio for the measured charging current and the charging current limit for the battery packs and a ratio for the measured discharging current and the discharging current limit for the battery packs.

For the example of FIG. 9, the measured charging current for battery pack 230A is 30A, and the battery system controller 240 calculates that battery pack 230A can take [(80/30)−1] or 1.67× more current than it is currently taking before reaching its charging current limit. Alternatively, the battery system controller 240 may calculate that battery pack 230A is using 37.5% of its charging current limit. For battery pack 230B, the measured charging current is 40 Amps, and the battery system controller 240 calculates that it can take [(80/40)−1] or 1× more current than it is currently taking before reaching its charging current limit, or that it is using 50% of its charging current limit.

For battery pack 230C, the measured charging current is 50 Amps, and the battery system controller 240 calculates that it can take [(80/50)−1] or 0.6× more current than it is currently taking before reaching its charging current limit, or that it is using 62.5% of its charging current limit. For battery pack 230C, the measured charging current is 45 Amps, and the battery system controller 240 calculates that it can take [(80/45)−1] or 0.77× more current than it is currently taking before reaching its charging current limit, or that it is using 56.2% of its charging current limit. Thus, battery pack 230C is the worst performing battery pack because it has the least remaining headroom (0.6×) before hitting its current limit.

When the worst performing battery pack is identified, the battery system controller 240 calculates a new system level charging current limit based on the worst performing battery pack. The proportion of the measured system charging current performance is calculated. For the example of FIG. 8, the battery pack 230A draws 18.18% of the measured system charging current and battery packs 230B, 230C, 230D draw 24.24%, 30.30%, and 27.27% respectively of the system charging current. The system battery controller 240 calculates a correction factor that is applied to the system level current limit to address the performance of the identified worst performing battery pack 230C. The correction factor is applied (e.g., added or subtracted) to the measured system current to determine the new or updated system level current limit.

To compute the correction factor, the difference between the pack level current limit of the worst performing battery pack and the measured current of the worst performing battery pack is calculated by the battery system controller 240. For battery pack 230C, the difference in current is 30 Amps. As explained previously herein, the calculated current difference of 30 Amps indicates the amount of additional charging current the worst performing battery pack can take before reaching its pack level charging current limit. The calculated current difference also indicates a portion of the total potential increase in system level charging current that the system can take before battery pack 230C hits its charging current limit. Hence, the contribution of battery pack 230C to potential system level charging current increases can be equated to the proportion of system charging current that battery pack 230C is drawing (i.e., 30.30%). The proportions of system current drawn by each of the battery packs is indicative of the split in system current due to electrical and electrochemical dynamics of the battery system, and the remaining current difference of battery pack 230C of 30 Amps is also the proportion of the potential increase that the system charging current can take before hitting a charging current limit. The remaining charging current that the system can draw is taken up by the other battery packs in the proportion that the other battery packs (230A, 230B, 230D) are drawing. The charging current difference of battery pack 230C and the charging current taken up by the rest of the battery packs is the correction factor applied to the measure system charging current.

If 30.30% of the system charging current headroom is 30 Amps (due to battery pack 230C), then the system charging headroom is 99 Amps (30A/.303), and 99 Amps is the charging current correction factor applied to the measured system current. The remaining 69 Amps not taken up by the worst performing battery pack is taken up by the other battery packs according to the proportion of the charging current they are using (the 18.18%, 24.24%, and 27.27% computed before). Because the charging current of the worst performing pack is below its pack level charging current limit, the correction the 99 Amp correction factor is added to the measured system charging current (165 Amps) to produce the updated system level charging current limit of 264 Amps. The updated system level charging current limit and the measured current are included in a ratio that is used to scale the operating current of all the battery packs including those packs that are not the worst performing pack. The charging current of the individual battery packs is scaled using a scaling equal to the updated system level charging current limit times the individual battery pack's proportion of the total system level current.

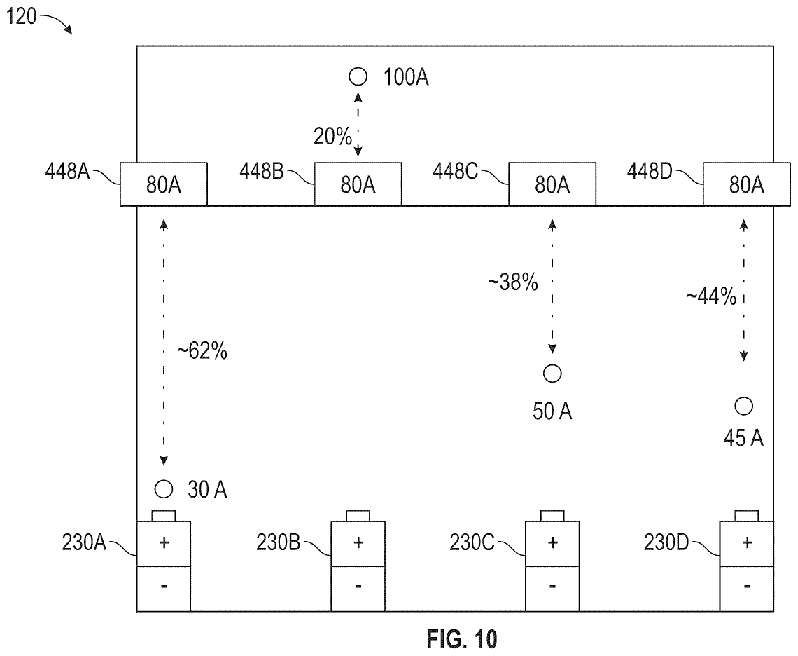

FIG. 10 is a diagram illustrating another example of operating a modular battery system 120. In the example of FIG. 10, the battery system controller 240 again receives 80 Amps as the pack level charging current limit for the battery packs from the pack controllers 235. The current sensors (not shown) indicate that the charging current measured by the current sensors is different for each of the battery packs. The charging current for battery pack 230A is 30 Amps, the charging current for battery pack 230B is 100 Amps, the charging current for battery pack 230C is 50 Amps, and the charging current for battery pack 230D is 45 Amps. Current sensor 448B indicates that battery pack 230B is exceeding its pack charging current limit by 20 Amps. The battery system controller 240 uses the information from pack current sensors, and system current sensor to determine that battery pack 230B is the worst performing battery pack. The battery system controller 240 may compute an updated system level charging current limit in response to detecting that the pack level charging current is exceeded and to tend to the worst performing battery pack.

The proportion of the measured system charging current is calculated for the battery packs. For the example of FIG. 10, the battery pack 230B draws 44.44% of the measured system charging current and battery packs 230A, 230C, 230D draw 13.33%, 22.22%, and 20.00% respectively of the system charging current. To compute the correction factor, the difference between the pack level current limit of the worst performing battery pack and the measured current of the worst performing battery pack is calculated by the battery system controller 240. For battery pack 230B, the difference in current is 20 Amps. Because the charging current limit is exceeded, the calculated current difference of 20 Amps indicates the amount of charging current the worst performing battery pack should be reduced to bring the charging current to its pack level charging current limit. The calculated current difference also indicates a portion of the total decrease in system level charging current to bring battery pack 230C to its pack level charging current limit.

Because the proportion of the system level charging current drawn by battery pack 230B is 44.44%, then the system charging current reduction is 45 Amps (20A/.4444), and 45 Amps is the charging current correction factor applied to the measured system current. Because the charging current of the worst performing pack is above its pack level charging current limit, the correction the 45 Amp correction factor is subtracted from the measured system charging current (225 Amps) to produce the updated system level charging current limit of 180 Amps. The updated system level charging current limit and the measured current are included in a ratio that is used to scale the operating current of all the battery packs including those packs that are not the worst performing pack. The charging current of all the individual battery packs is scaled using a scaling equal to the updated system level charging current limit (180A) times the individual battery pack's proportion of the total system level current. For battery pack 230A the charging current is scaled to 23.9 A. For battery pack 230B, the charging current is scaled to 79.9 A. For battery pack 230C, the charging current is scaled to 40A. Far battery pack 230D, the charging current is scaled to 36A.

The battery system controller 240 may dynamically update the system level charging current limit at a subsequent time using the technique described regarding the example of FIG. 9. The techniques in the examples of FIGS. 9 and 10 can also be applied by the battery system controller 240 to manage the discharging currents of the battery packs and bring the discharging currents to within the pack level discharging current limits by calculating the correction factor and adjusting the system level discharging current accordingly.

Because the worst performing pack is tended to by adjusting the current (charging or discharging) at the system level, the techniques described herein address the issue of inter-pack currents between battery packs of the battery pack system.

### INDUSTRIAL APPLICABILITY

In an example of operating a modular battery system for a work machine online according to this disclosure, individual battery packs of the battery system need to be operated within safe operating conditions.

System level current limits can automatically be determined and set to operate individual packs and the system within safe operating conditions. The algorithm used to determine the system level current limits should be designed in such a way that it considers the worst-case conditions of the constituent packs that are online. Distinction may be made between battery packs of the system that are charging versus the battery packs that are discharging, and correspondingly the system charge current limit and the system discharge current limit should be calculated. The calculation of these limits should also take into account current imbalances between battery packs that arise due to pack resistance, sequencing, aging and discharging of a battery pack into another battery pack. The process used to determine the system current limits should be scalable to different pack types and battery system architectures.

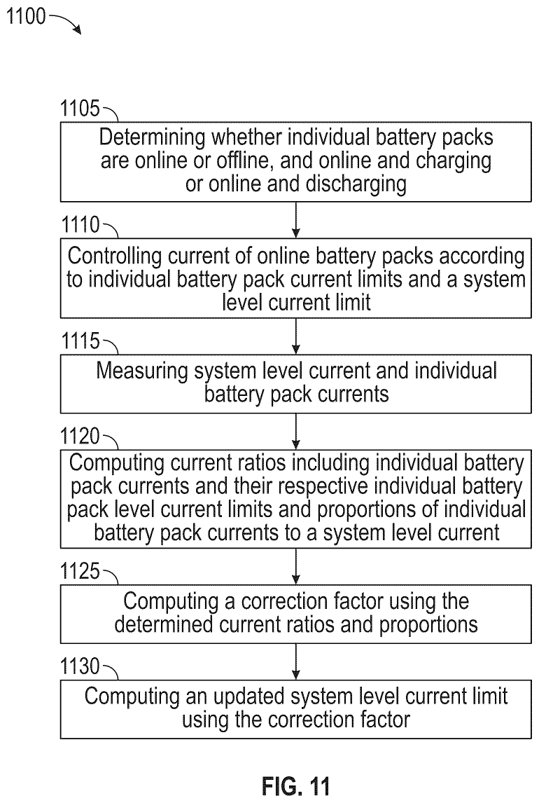

FIG. 11 is a flow diagram of an example of a method 1100 of operating a machine battery system that includes multiple battery packs connectable in parallel, such as the modular battery system 120 of FIG. 2. The method 1100 may be performed by a battery system controller, such as the battery system controller of FIG. 2.

At block 1105, the battery system controller determines whether the individual battery packs of the battery system are online or offline. The battery system controller may also determine which battery packs are online and charging, and which battery packs are online and discharging. The battery system may include current sensors that indicate the current in each of the battery packs. The battery system controller may detect that a battery pack is online from the current sensor. In some examples, each of the battery packs includes a battery pack controller and the battery pack controller reports status of the battery pack to the system controller. The battery pack controllers may determine pack level current limits for its respective individual battery pack. The pack level current limit may be determined using factors such as the voltage of the battery pack, the state of charge of the battery pack, the state of health of the battery pack, temperature of the battery pack, etc.

The battery system controller receives a pack level current charging limit and a pack level current discharging limit for each battery pack that is enforced based on the mode of the battery pack, i.e., whether the battery pack is online and charging or online and discharging. The battery system controller also calculates a system level current limit. The battery system controller may also calculate a system level charging current limit and a system level discharging current limit. The battery system controller may set an initial system level current limit to a default value or set the system level current limit based on the demand on the load of the battery system.

At block 1110, the battery system controller controls current of online battery packs using individual battery pack current limits and a system level current limit of the battery system. The battery system controller may set one or both of a system level charging current limit and a system level discharging current limit.

At block 1115, the battery system controller determines a measurement of the system level current and the individual battery pack currents. The battery system controller may also use current sensor information to determine inter battery pack current flows between the battery packs of the system.

At block 1120, the battery system controller computes current ratios including the individual battery pack currents and their respective individual battery pack level current limits. The battery system controller also computes proportions of individual battery pack currents to the system level current. At block 1125, the battery system controller computes a correction factor using the computed ratios and proportions. The determined correction factor may be a current level (e.g., in Amps) used to adjust the system level current limit. At block 1130, the battery system controller computes an updated system current limit using the correction factor.

In some examples, the battery system controller identifies the worst performing battery pack. If none of the battery packs has exceeded its pack level current limit, the worst performing battery pack may be the battery pack having a current ratio indicating its measured current is closest to its pack level current limit, and the correction factor is the sum of the current differences of all the individual battery packs before the worst performing battery pack reaches its charging current limit. The correction factor is added to the measured system current to set the system level current limit.

If one or more battery packs has exceeded its pack level current limit, the worst performing battery pack is the battery pack that is the most over its limit. The correction factor is the sum of the current decrease of all the individual battery packs before the worst performing battery pack is reduced to its charging current limit. The correction factor is subtracted from the measured system current to set the system level current limit.

At block 1130, the battery system controller scales the individual battery pack currents according to a ratio including the measured system current and the updated system current limit. For example, the battery system controller may scale the system level current by a ratio of the updated system level current limit to the measured system level current. The updated system level current limit may cause the battery system controller to decrease the demanded pack level currents when the current of the worst performing battery pack is close to or over its pack level current limit. The updated system level current limit may cause the pack controllers to increase the pack level currents when the current of the worst performing battery pack is not very close to its pack level current limit.

The battery system controller may determine separate correction factors for charging current and discharging current. The charging current correction factor may be used to update a system level charging current limit, and the discharging current correction factor may be used to update a system level discharging current limit. Whether the battery system controller computes one or both of the charging current correction factor and the discharging current correction factor, and corrects one or both of the system level charging current limit and the system level discharging current limit using the correction factor, may depend on the mode of the battery packs of the battery system, such as whether there are battery packs online and charging and online and discharging.

The system level approach described herein of managing battery pack currents based on scaling all the battery pack currents to tend to one of the battery packs accounts for not only the individual battery pack limits, but also the inter battery pack current flows. Not considering the inter battery pack current flows may cause pack level currents to be breached under high load conditions or high energy charging conditions of work machines. Managing operation of the battery packs by optimizing system level current limits based on the prevailing conditions of the individual battery packs and the battery system, provides a robust strategy for managing the battery systems of work machines.

The above detailed description is intended to be illustrative, and not restrictive. The scope of the disclosure should, therefore, be determined with references to the appended claims, along with the full scope of equivalents to which such claims are entitled.

What is claimed is:

1. A modular battery system, the battery system comprising:
a battery bus;
multiple battery packs connectable in parallel to the battery bus to provide a system current, wherein a battery pack includes multiple battery strings that include multiple battery modules, which in turn include multiple battery cells, and a battery pack provides a battery pack current to the battery bus; and
a battery system controller configured to:
determine whether individual battery packs are online or offline;
control current of online battery packs according to individual battery pack current limits of online battery packs and a system level current limit of the battery system;
determine system current and individual battery pack currents;
compute current differences between the individual battery pack currents and their respective individual battery pack level current limit;
compute a correction factor using the determined current differences; and
update the system current limit using the correction factor.

2. The system of claim 1, including:
multiple current sensors configured to provide, to the battery system controller as the individual battery pack currents, a measure of individual battery pack currents provided to the battery bus and inter battery pack current flow between the individual battery packs.

3. The system of claim 1, wherein the battery system controller is configured to:
determine proportions of the determined system current provided by the individual battery packs;
compute the correction factor using the computed current differences and the determined proportions of the determined system current; and
compute the updated system current limit using the determined system current and the correction factor.

4. The system of claim 3, wherein the battery system controller is configured to compute the updated system current limit by:
adding the correction factor to the determined system current when the determined individual battery pack currents of the individual battery packs are less than their respective individual battery pack current limit; and
subtracting the correction factor from the determined system current when one or more of the determined individual battery pack currents of the individual battery packs is greater than its respective individual battery pack current limit.

5. The system of claim 1, wherein the battery system controller is configured to:
identify which individual battery packs are online and charging;
receive individual battery pack level charging current limits;
determine system level charging current and individual battery pack level charging currents;
compute charging current differences between the individual battery pack charging currents and their respective computed individual battery pack level charging current limit;
compute an updated system charging current limit using the computed charging current differences; and
scale the individual battery pack charging currents of the battery packs that are online and charging using a proportion of the battery pack current of the determined system charging current and the updated system charging current limit.

6. The system of claim 5, wherein the battery controller is configured to:
identify a worst performing battery pack as an individual battery pack having a highest current ratio of its determined charging current and its charging current limit;
compute the correction factor as a sum of the charging current differences of the individual battery packs before the worst performing battery pack reaches its charging current limit; and
compute an updated system charging current limit by adding the determined system level charging current, a least charging current difference, and the sum of the charging current differences of other individual battery packs.

7. The system of claim 1, wherein the battery controller is configured to:
identify which individual battery packs are online and discharging;
receive individual battery pack level discharging current limits;
determine system level discharging current and individual battery pack level discharging currents;
compute discharging current differences between the individual battery pack discharging currents and their respective computed individual battery pack level discharging current limit;
compute an updated system discharging current limit using the computed discharging current differences; and
scale the individual battery pack discharging currents of the battery packs that are online and discharging using a proportion of the battery discharging current of the determined system discharging current and the updated system discharging current limit.

8. The system of claim 7, wherein the battery controller is configured to:
identify a worst performing battery pack as an individual battery pack having a highest ratio of its determined discharging current and its discharging current limit;
compute the correction factor as a sum of the discharging current differences of the individual battery packs before the worst performing battery pack reaches its discharging current limit; and
compute an updated system discharging current limit by adding the determined system level discharging current, a least discharging current difference, and the sum of the discharging current differences of other individual battery packs.

9. A method of operating a machine battery system that includes multiple battery packs connectable in parallel, the method comprising:
determining, using a battery system controller, whether individual battery packs are online or offline;
controlling current of online battery packs according to individual battery pack current limits of online battery packs and a system level current limit of the battery system;
measuring system level current and individual battery pack currents;
computing current ratios including the individual battery pack currents and their respective individual battery pack level current limits;
computing proportions of individual battery pack currents to the system level current;
computing a correction factor using the determined current ratios and proportions; and
computing an updated system current limit using the correction factor.

10. The method of claim 9, wherein measuring individual battery pack currents includes measuring inter battery pack current flow between the individual battery packs.

11. The method of claim 9, wherein the computing the updated system current limit includes:
determining proportions of the measured system current provided by the individual battery packs;
computing the correction factor using the determined current ratios and the determined proportions of the measured system current; and
computing the updated system current limit using the measured system current and the correction factor.

12. The method of claim 11, wherein the computing the updated system current limit includes adding the correction factor to the measured system current when the measured individual battery pack current of the individual battery packs is less than its respective individual battery pack current limit.

13. The method of claim 11, wherein the computing the updated system current limit includes subtracting the correction factor from the measured system current when the measured individual battery pack current of one or more of the individual battery packs is greater than its respective individual battery pack current limit.

14. The method of claim 11, including:
identifying which individual battery packs are online and charging;
computing individual battery pack level charging current limits;
wherein the measuring the system level current includes measuring system level charging current and individual battery pack level charging currents;
wherein the computing the current ratios includes computing charging current ratios of the individual battery pack charging currents and their respective computed individual battery pack level charging current limit;
wherein the computing the updated system current limit includes:
computing an updated system charging current limit using the computed charging current ratios; and
scaling the individual battery pack charging currents of the battery packs that are online and charging using a proportion of the battery pack charging current of the measured system charging current and the updated system charging current limit.

15. The method of claim 14,
wherein the computing the updated system charging current limit includes:
identifying a worst performing battery pack as an individual battery pack having a highest ratio of its measured charging current and its charging current limit;
computing the correction factor using a sum of charging current differences of the individual battery packs before the identified worst performing battery pack reaches its charging current limit; and
computing an updated system charging current limit by updating an existing charging current limit with the correction factor.

16. The method of claim 11, including:
identifying which individual battery packs are online and discharging;
computing individual battery pack level discharging current limits;
wherein the measuring the system level current includes measuring system level discharging current and individual battery pack level discharging currents;
wherein the computing the current ratios includes computing discharging current ratios of the individual battery pack discharging currents and their respective computed individual battery pack level discharging current limit;
wherein the computing the updated system current limit includes:
computing an updated system discharging current limit using the computed discharging current ratios; and
scaling the individual battery pack discharging currents of the battery packs that are online and discharging using a proportion of the discharge currents of the individual battery packs of the measured system discharging current and the updated system discharging current limit.

17. The method of claim 16,
wherein the computing the updated system discharging current limit includes:
identifying a worst performing battery pack as an individual battery pack having a highest current ratio of its measured discharging current and its discharging current limit;
computing the correction factor using a sum of discharging current differences of other individual battery packs before the identified worst performing battery pack reaches its discharging current limit; and
computing an updated system discharging current limit by updating an existing discharging current limit with the correction factor.

18. A non-transitory computer-readable storage medium including instructions that, when performed by a battery system controller of a modular battery system having multiple battery packs, cause the battery system controller to perform operations comprising:
determining the battery packs of the battery system that are online;
receiving individual battery pack current limits from pack controllers of online battery packs and setting a system level current limit of the battery system;
measuring system current and individual battery pack currents;
computing current ratios including the individual battery pack currents and their respective individual battery pack level current limit;
computing an updated system current limit using a current factor; and
scaling a current demand for the individual battery packs according to a proportion of the current of the individual battery packs of the measured system current and the updated system current limit.

19. The non-transitory computer-readable storage medium of claim 18, including instructions that cause the battery system controller to perform operations including:
determining proportions of the system current provided by the individual battery packs;
computing a correction factor using determined current differences and the determined proportions of the system current; and
computing the updated system current limit using the determined system current and the correction factor.

20. The non-transitory computer-readable storage medium of claim 19, including instructions that cause the battery system controller to perform operations including:
adding the correction factor to the determined system current when the individual battery pack current of the individual battery packs is less than its respective individual battery pack current limit; and
subtracting the correction factor from the determined system current when the individual battery pack current of one or more of the individual battery packs is greater than its respective individual battery pack current limit.
